(19) United States
(12) Patent Application Publication
(10) Pub. No.: US 2019/0204140 A1
(43) Pub. Date: Jul. 4, 2019

(54) METHOD AND DEVICE FOR SUPPORTING AND WEIGHING A SHIPPING CONTAINER

(71) Applicant: Cindicium Pte Ltd, Forum (SG)

(72) Inventor: David Robin Bean, Surry Hills, NSW (AU)

(21) Appl. No.: 16/303,258

(22) PCT Filed: May 22, 2017
(86) PCT No.: PCT/IB2017/000687

§ 371 Date: Nov. 20, 2018

(30) Foreign Application Priority Data
May 20, 2016 (AU) 2016901904
Mar. 16, 2017 (AU) 2017900913

(51) Int. Cl. G01G 19/08; G01G 19/14; B66F 3/36; B65D 90/00

(52) U.S. Cl. CPC G01G 19/08; G01G 19/14; B60P 7/132; B65D 90/0026; B66F 3/36

(57) ABSTRACT

A method for supporting and weighing a shipping container, the method including the steps of:
providing a shipping container having a corner casting (20);
providing a twistlock (30);
locating the shipping container such that the twistlock (30) is engaged with the corner casting (20);
locating a lifting device (2) inside the corner casting (20), the lifting device (1) having a pair of jaws (3, 4) and an actuator (5);
moving the pair of jaws (3, 4) apart using the actuator (5) from a first position to a second position to lift the shipping container relative to the twistlock (30),
   wherein in the second position the jaws (3, 4) support at least a portion of the weight of the shipping container, and wherein the shipping container remains substantially engaged with the twistlock (30) in the second position;
locating a weighing device (10) between the shipping container and the twistlock (30); and
moving the pair of jaws (3, 4) from the second position to the first position to apply a force to the weighing device (10), the weighing device (10) providing an indication of the force applied to the weighing device (10).

### FIELD

The present invention relates to a lifting and weighing system and, in particular, to a portable assembly to lift and weigh shipping containers or the like.

### BACKGROUND

Knowing the weight of a container or other similar objects is important to a variety of stakeholders such as customers, suppliers, road authorities and those that handle movement of those containers and objects. A series of accidents at sea, for example, led to a move by the International Maritime Organisation (IMO) to enforce weighing of shipping containers. Though discussion is directed towards shipping containers, this document is applicable to other containers and objects.

Although it is allowable to weigh all the contents of a container and add them to the tare (empty or unloaded weight) this method requires a lot of weighing, requires that the tare weight of the empty container is correct and if using a calculated method, requires a validation of what is actually loaded into the container. Direct container weighing gives a direct, error free answer to the weight of the container.

Although the new rules only require a gross verified mass, stakeholders such as shipping lines, truck operators and stevedores prefer to know at least the centre of mass of the container in the horizontal plane and preferably the centre of mass in 3 dimensions to account for stability (when loading containers onto transport devices).

Weighing of containers is currently done by a variety of means. Traditional weighing on a vehicle requires a separate weighing of the vehicle to get the tare weight of the container. This method is usually done on a weighbridge and is unable to determine the container weight when more than one container is loaded on the vehicle. Weighing on the ground is also a common method but is not suitable in many cases as it requires the container to be removed from the vehicle. Trailers can be equipped to record the load via the suspension of the trailer. This method requires conversion of the trailer, involves a high capital cost, high maintenance cost through damage and in most instances cannot weigh containers if there is more than one on the trailer. On-trailer direct weighing is only possible in a limited number of forms. These rely on the container being lifted from the trailer by use of stands (fixed or wind up); by use of a weighing device mounted on a spreader (a device used at ports to lift and move containers) by lifting the container and then lowering it onto the weigh cells; by lifting the container while the trailer is on a weighbridge and registering the difference in weight. On-ground legs are also impractical and potentially dangerous as the approach relies on the supports having a good base and can fail entirely if the container is bumped or a leg fails or slips. Spreader methods rely on a relatively large device being able to support the container (up to 50 tonnes to allow for safe measurement of potentially overweight containers). A lifting spreader in most cases also records only a total weight and not a weight distribution.

Further, in many cases the ideal situation, from a transport company's perspective, is for the container to be weighed en route or at the originator's premises which means considerable infrastructure is required.

Though it is possible to incorporate weighing devices into the trailer itself, this would require each trailer to be regularly calibrated, a large capital cost and the likelihood of wear and damage is significant over and above the high cost of calibrating the weighing devices.

A particular challenge with any method to lift the container from a trailer is that there is often not an obvious place to lift the container. If you lift the container by placing a jack between the truck bed and the container, there are potential issues in lifting under the rails as this can damage the container or the vehicle. It is also getting much harder to find a place to jack a container upwards. In most cases the trailer frame is well below the container floor making jacking dangerous.

There is a need to weigh a container on the vehicle, without the need to tare, without the container being unsupported at any time, using a small amount of equipment that can be cheaply and readily be deployed at any site at low cost and high accuracy.

Such a device would also ideally be capable of identifying the container that is being weighed without reading errors and send the result direct to those who need to know the weight instantaneously.

### OBJECT OF INVENTION

It is an object of the present invention to substantially overcome or at least ameliorate one or more of the disadvantages of the prior art, or to at least provide a useful alternative.

### SUMMARY OF INVENTION

### Brief Description of Drawings

A preferred embodiment of the invention will now be described, by way of example only, with reference to the accompanying drawings, wherein:

FIG. 1 shows a lifting device placed in a container corner casting;

FIG. 2 shows the lifting device of FIG. 1 adjusting position;

FIG. 3 shows the lifting device of FIG. 1 lifting the container upwards;

FIG. 4 shows a weighing device of the present invention being inserted under the container;

FIGS. 5a to 5e shows stages of the present invention as shown on a mobile platform;

FIGS. 6a to 6c show examples of a screw thread drive and other linear actuators; and

FIG. 7 shows an example of a mini hydraulic cylinder.

FIG. 8 shows an example of a mechanism to transfer load out from beneath the container of FIG. 1.

FIG. 9 shows an alternative embodiment of the container lifting and weighing assembly.

FIG. 10 shows two section views of another alternative embodiment of the container lifting and weighing assembly in a first and a second position.

FIG. 11 shows yet another alternative embodiment of the container lifting and weighing assembly.

FIGS. 12a, 12b and 12c show the operation of a double-sided wedge as used in preferred embodiments of the container lifting and weighing assembly.

### DESCRIPTION OF EMBODIMENTS

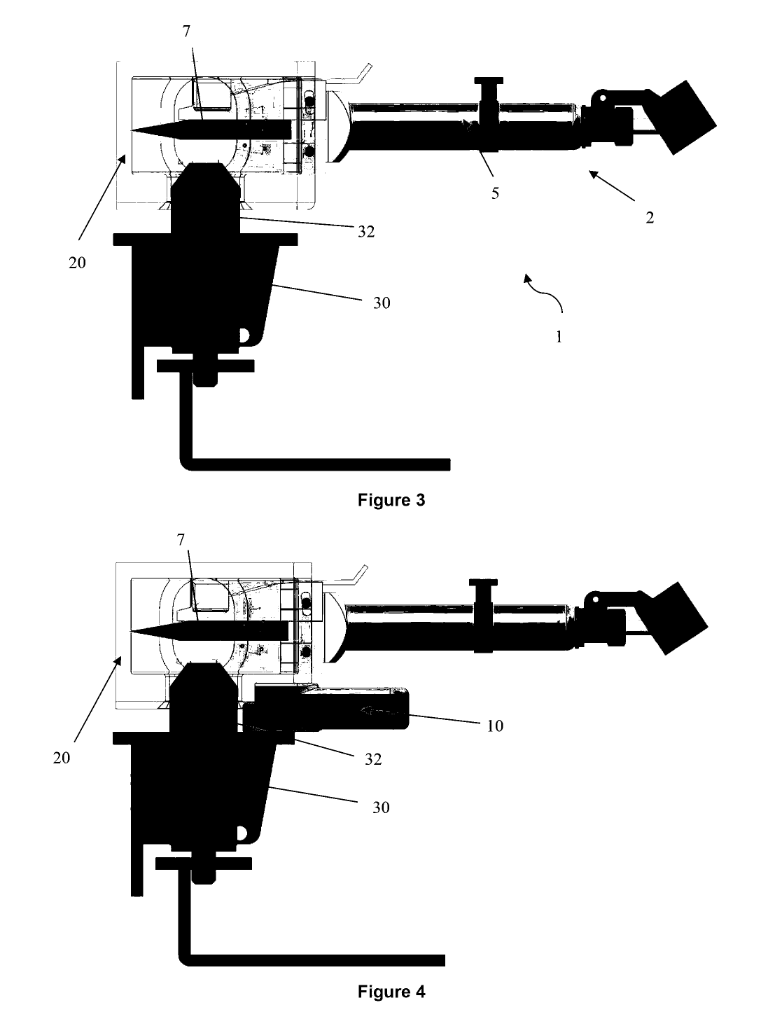

As shown in the Figures there is disclosed a container lifting and weighing assembly 1. The portable assembly 1 having a lifting device 2 having a lifting member in the form of a pair of jaws 3, 4 and an actuator 5. The actuator 5 in use moves the jaws 3, 4 from a closed position (FIG. 1) to an opened position (FIG. 3) by forcing a protrusion 7 between the jaws. The closed position may be referred to as a first position, and the open position may be referred to as a second position. The assembly 1 further includes a weight indicator in the form of a weighing device 10 locatable in use between a container to be weighed and a support surface 30. In the embodiment shown, in for example FIG. 4, a corner casting 20 of a shipping container is shown and a twist lock 32 from a trailer is shown. The container is attached (i.e. engaged) to at least a part of said support surface (i.e. the twist lock) during weighing. This provides safety.

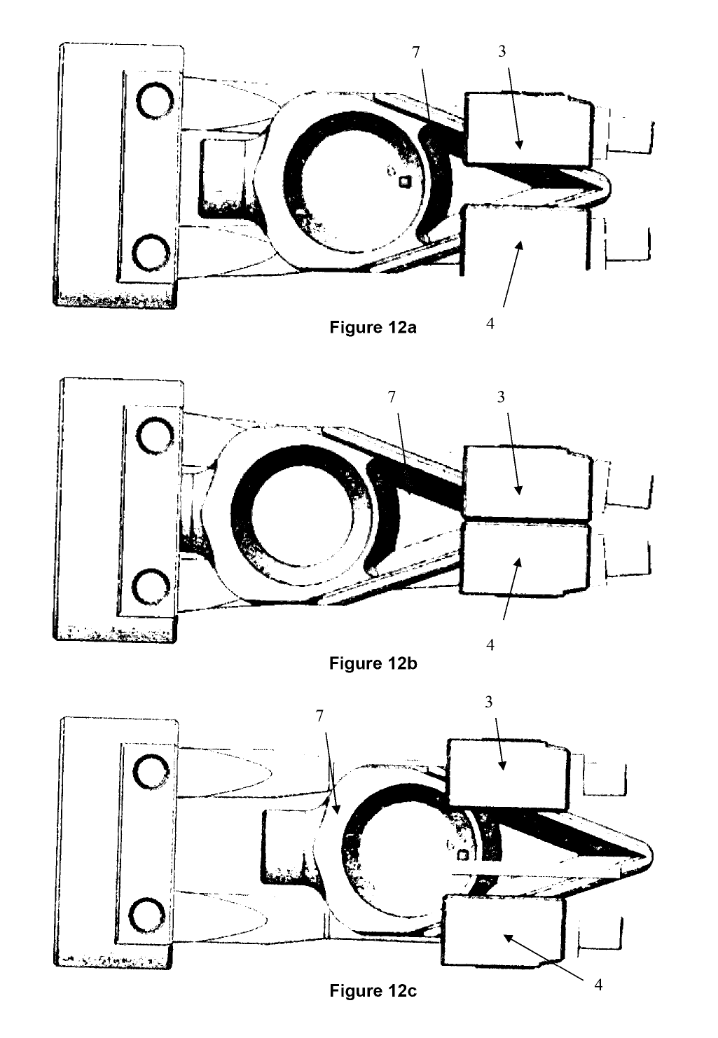

In a preferred embodiment, the protrusion 7 is a double-sided wedge as best seen in FIGS. 12a to 12c. This configuration allows the container to be lifted from the twist lock 32 without causing off-axis movement as would be expected from single-sided wedges.

In the preferred form, the weighing device 10 includes a load cell or the like. This load cell may be of several types, including strain gauge based, hydraulic or pneumatic, where the pressure is measured to get a weight. As shown in FIG. 8, it is also possible to insert a mechanism 40 into the corner casting 20 which transmits the load out from beneath the container whereby other force or load measuring devices 10 can be attached to record the load.

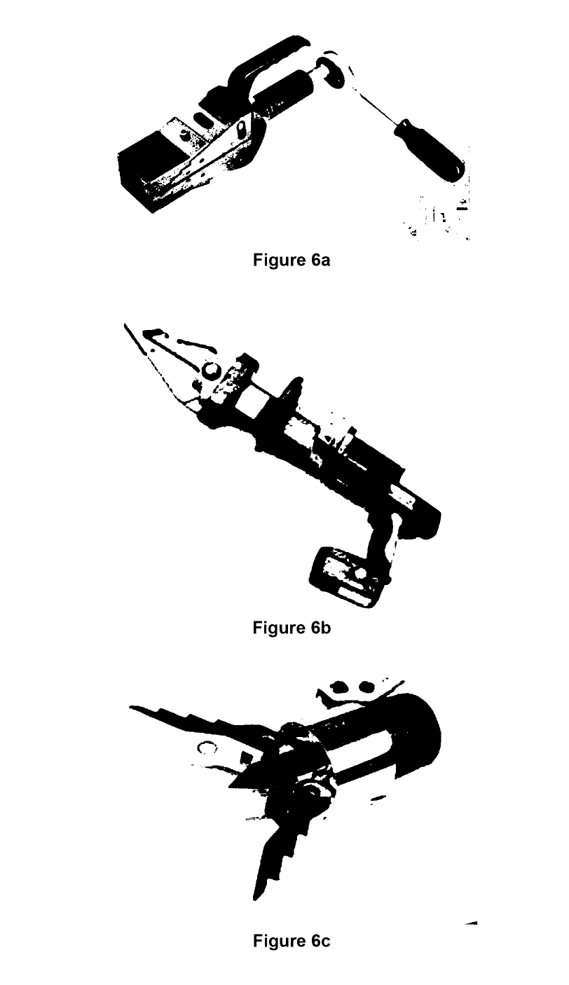

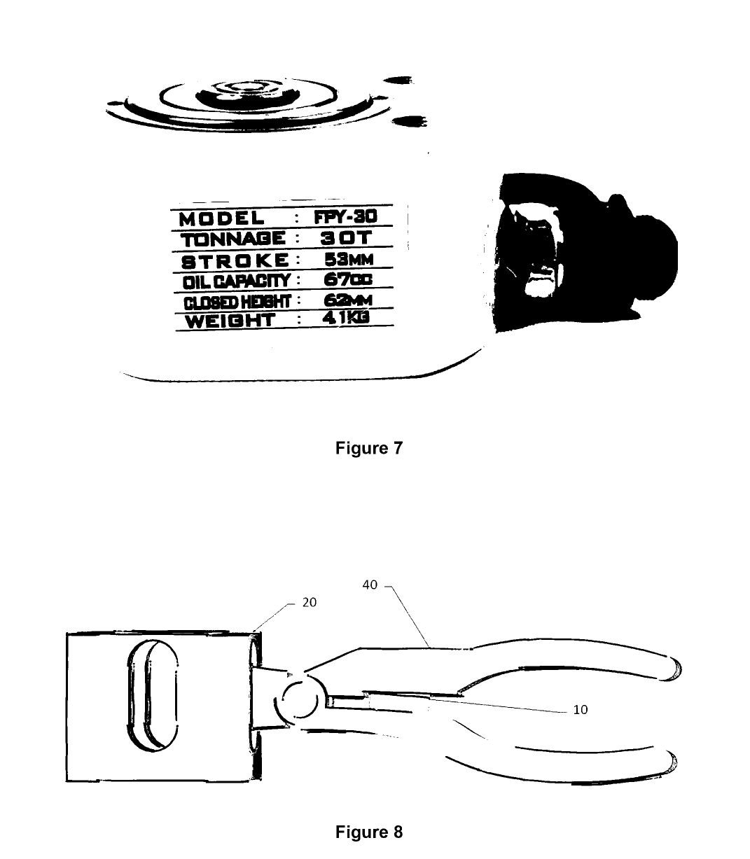

Further, in a preferred form, the actuator 5 is hydraulic. It is also possible to use a screw thread drive or any other linear actuator, for example as shown in FIGS. 6a to 6c. An alternative method is to use a mini hydraulic cylinder, for example as shown in FIG. 7.

The assembly 1 is portable and includes a series of lifting devices 2 and weighing devices 10 locatable in a backpack, carry bag or the like (not shown).

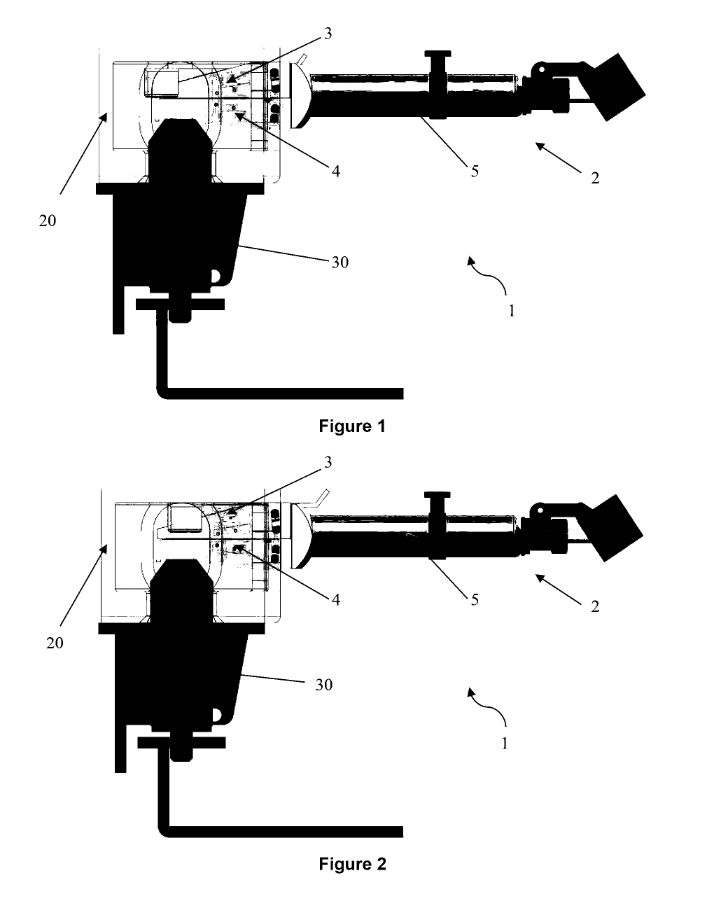

In the preferred method and as shown in the figures, the lifting device 2 is placed inside a corner casting 20 and rests on the twist lock 32. The lifting device 2 is operated by a user to lift the container upwards and away from the supporting surface 30 by moving the jaws 3, 4 from the first position to the second position as show in FIGS. 2 and 3. In the second position the jaws 3, 4 are further spaced apart than in the first position, thereby supporting and lifting the container. The container remains engaged (in some form) with the twist lock 32 to prevent sliding off. An adjustment is made to eliminate the gap between the jaws 3, 4 and the corner casting 20. The weighing device 10 is inserted beneath the corner casting 20 and the container is lowered onto the load cell 10. The weight and load distribution may then be recorded.

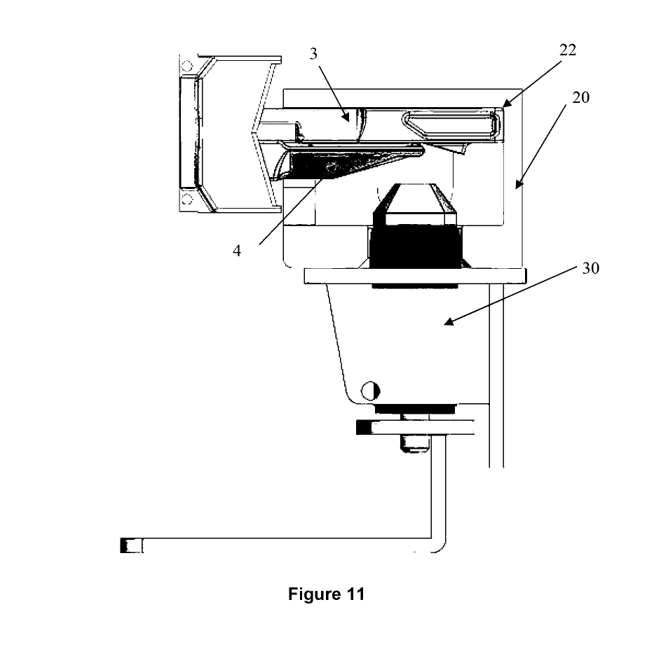

In a preferred embodiment, as shown in FIGS. 10 and 11, the jaw 3 engaging an upper inner surface 21 of the corner casting 20 is formed to extend, when inserted into the corner casting 20, substantially fully into the corner casting 20. This arrangement permits the load transfer from the container to the jaw 3 to occur at the inner corners 22 of the upper inner surface 21 of the corner casting 20, which are less likely to fail under load.

In instances where a container must be lifted higher, a temporary block may be inserted between the corner casting and the trailer bed. This may at least take the load while the lifting device is adjusted to allow a higher lift through use of a packing piece or a second lifter with a higher lift capacity.

One part of the method of the present invention includes a lifting system. A system for lifting the container above the bed of the trailer by a small distance allows a weighing device to be placed beneath the container. A system that can work on the widest variety of trailer shapes and designs is provided. The lifting device 2 relies on a twist lock 2 being present or a firm surface on which the container rests. Almost every trailer used to carry containers provides these features. One that does not stress the container or the trailer by large unbalanced loads is also provided. As the container is only lifted about 50 mm, for example to keep in contact with the twist lock 32, bumping the container is unlikely to cause slippage of the load due to the reduced moment arm. A system that ensures the load is always secure from falling and allows a determination of whether a container is dangerously top heavy. This determination is performed by measuring the change in recorded weight by the weighing device 10 as the container is lifted or lowered. Using the known dimensions of the container it is possible to determine whether the centre of gravity is dangerously high.

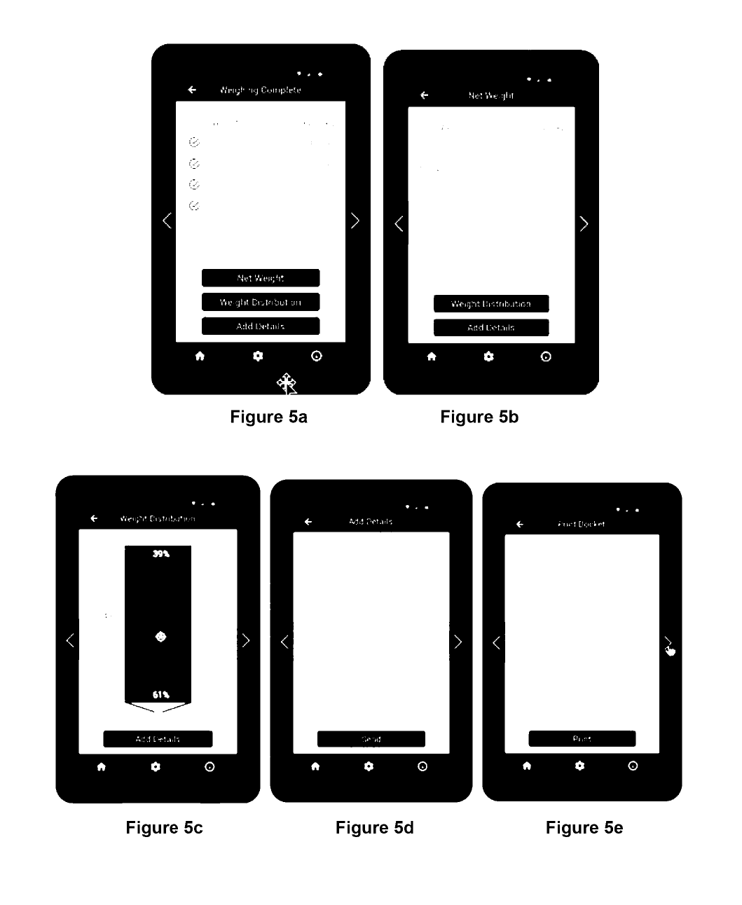

The second part of the method is a simple load cell arrangement where weighing units or devices 10 are placed under the container at the corner castings 20. Four is best but one or two could also be utilised. These are electronically enabled fitted with a communications device to allow wireless transmission of the individual weights to a device which collates the information and calculates the total weight and other characteristics of the container such as direction the container is facing on the vehicle, position on the vehicle (and thus loads on the axles), seal number and how stable it will be, based upon above determination of top heaviness, to allow the total weight as well as the load distribution to be accurately determined and reported. A system that stores the weight along with the details of the vehicle, container and weighing operator for ready and rapid transmission to other parties by use of wired or wireless communications or the like is provided. The system also keeps track of weighing location and time, equipment status and history as shown in FIGS. 5a to 5e.

Further, having a system that allows truck drivers, weighers and the like to schedule weighing time and location, manages communications and payment is also provided. The app is designed to combine job allocation with the weighing function. Doing this allows the container information to be sent to the driver and thus reduces errors in typing in numbers, locations and job numbers. This same app is able to establish the time that the weigh is needed and act as a form of scheduling tool (like Uber). The app is GPS enabled so that travel times and relative locations can be used when deciding who will be given a particular weighing task.

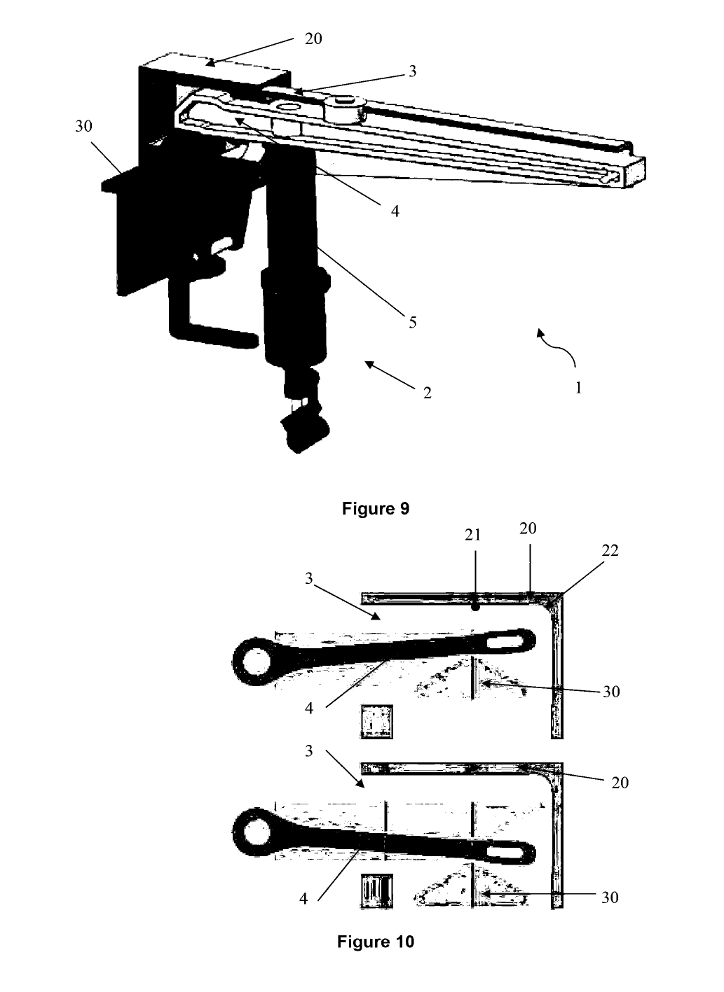

In a further embodiment, as shown in FIG. 9, the above has the lifting device 2 and the weight indicator in the form of the weighing device 10 combined into a single device whereby the lifting device is able to record the weight it is lifting. A common method of doing this is a hydraulic cylinder which also records the pressure and thus infers the weight.

The invention, at least in a preferred embodiment, combines a physical lifting system, a simple, accurate weighing system, an inbuilt means of identifying the vehicle and the container as well as instant communication of the results. The system also monitors the service life of the weighing cells in number of weighs and the individual weights that have been measured and, in particular, if they have been struck or impacted using the weighing system and/or acceleration detection sensors. This allows damaged cells to be immediately checked and removed from service if required.

The system can be deployed in a backpack or similar, meaning that it can be carried and operated almost anywhere that a container is stored but mainly on the back of a truck or on many rail vehicles.

Being simple, light, inexpensive and portable means that entirely new business models for weighing can be deployed.

The lifting device of the present invention, in a preferred embodiment, relies on having a twistlock 32 or a firm base for the container. This is present on almost every trailer used to carry containers.

The device is primarily designed to weigh containers mounted on corner castings 20 on vehicles, principally trucks, but can also be used on trains, land (on ground) and ships.

The invention at least in a preferred embodiment therefore allows direct, accurate weighing on the back of a truck or other vehicle in complete safety and without needing to tare the weight of the trailer. The weight is transmitted automatically along with details of the container and vehicle. Importantly, there is often nowhere on the back of the trailer to jack up from, and this may at least be addressed by lifting the container from within the corner casting, either bearing down on to the twistlock or on to the trailer beneath through the hole in the corner casting. The device can be carried and operated by one person in complete safety and requires no particular location for the weighing and the ground does not need to be dead level. The load cells, via their accelerometers, have an artificial horizon and thus can detect the angle at which they are sitting. This angle can be factored in the weight and weight distribution calculations. For instance, it could be deployed at a truck stop with no need for infrastructure as it keeps the container safely attached to the truck at all times. The same basic mechanism can also be used to weigh containers on ground. Cheap, fast easy weighing makes it practical to weigh at customer premises thus ensuring loads are within acceptable range on-road and allowing the weight to be sent to the port much earlier. The system also gives an indication of top heaviness as above. This is important for weight distribution and detecting load shift.

Although the invention has been described with reference to specific examples, it will be appreciated by those skilled in the art that the invention may be embodied in many other forms.

1. A method for supporting and weighing a shipping container, the method including the steps of:
providing a shipping container having a corner casting;
providing a twistlock;
locating the shipping container such that the twistlock is engaged with the corner casting;
locating a lifting device inside the corner casting, the lifting device having a pair of jaws and an actuator;
moving the pair of jaws apart using the actuator from a first position to a second position to lift the shipping container relative to the twistlock,
wherein in the second position the jaws support at least a portion of the weight of the shipping container, and wherein the shipping container remains substantially engaged with the twistlock in the second position;
locating a weighing device between the shipping container and the twistlock; and
moving the pair of jaws from the second position to the first position to apply a force to the weighing device, the weighing device providing an indication of the force applied to the weighing device.

2. The method of claim 1, wherein the lifting and weighing devices are provided in a carry bag prior to being located inside the corner casting.

3. A method for supporting and weighing a shipping container, the method including the steps of:
providing a shipping container having a corner casting;
providing a twistlock;
locating the shipping container such that the twistlock is engaged with the corner casting;
locating a lifting and weighing assembly inside the corner casting, the lifting and weighing assembly having a pair of jaws, an actuator and a weighing device, the weighing device providing an indication of a force applied to the lifting and weighing assembly; and
moving the pair of jaws apart using the actuator from a first position to a second position to lift the shipping container relative to the twistlock,
wherein in the second position the jaws support at least a portion of the weight of the shipping container such that the weighing device provides an indication of the portion of the weight of the shipping container being supported by the jaws; and
wherein in the second position the shipping container remains substantially engaged with the twistlock.

4. The method of claim 3, wherein the lifting and weighing assembly is provided in a carry bag prior to being located inside the corner casting.

5. The method of any one of claims 1 to 4, wherein the weighing device includes a load cell.

6. The method of any one of claims 1 to 5, wherein the actuator is hydraulic.

7. The method of any one of claims 1 to 6, further including the step of:
locating a load transfer mechanism in the corner casting, the load transfer mechanism being associated with a second weighing device, wherein the second weighing device is located outside the corner casting.

8. A container lifting and weighing assembly having:
a lifting device, the lifting device having a pair of jaws and an actuator, said actuator in use moves said jaws from a closed position to an opened positioned to lift a container from a support surface; and
a weighing device, locatable in use between the container to be weighed and the support surface once the lifting device has lifted the container to provide an indication of a weight of the container to be weighed when said jaws move from an opened position to a closed position.

9. A container lifting and weighing assembly according to claim 8, wherein said support surface is part of a twist lock inside a corner casting of said container.

10. A container lifting and weighing assembly according to claim 9, wherein, in combination, the lifting device abuts the support surface and a surface of the corner casting of said container, and the weighing device abuts a second surface of the twist lock and a second surface of the corner casting of the container.

11. A container lifting and weighing assembly according to claim 9 or 10 wherein while the jaws are in an opened position said container remains substantially attached to said twist lock.

12. A container lifting and weighing assembly according to claim 8, wherein said support surface is a ground surface.

13. A container lifting and weighing assembly according to claim 12, wherein said container is lifted no more than about 50 mm from the ground surface during weighing.

14. A container lifting and weighing assembly according to any one of claims 8 to 13, wherein said weighing device includes a load cell.

15. A container lifting and weighing assembly according to any one of claims 8 to 14, wherein said actuator is hydraulic.

16. A container lifting and weighing assembly according to any one of claims 8 to 15, wherein said assembly is portable and includes a carry bag to transport said lifting device and weighing device.

17. A container lifting and weighing assembly according to claim 16, wherein said assembly includes four lifting and weighing devices in each carry bag.

18. A container lifting and weighing assembly according to any one of claims 8 to 17, wherein said assembly includes a plurality of weighing devices.

19. A container lifting and weighing assembly according to any one of claims 8 to 18, wherein said assembly includes a load transfer mechanism associated with a second weighing device positioned offset from a line of support when said jaws are lifting said container.

20. A container lifting and weighing assembly having:
a lifting device having a lifting member and an actuator, the actuator configured to move the lifting member between a first position and a second position to lift a container from a support surface; and
a weight indicator configured to provide an indication of the weight of the container.

21. The container lifting and weighing assembly of claim 20, wherein the weight indicator is a weighing device locatable, in use, between the container and the support surface when the container is lifted, the weighing device providing an indication of the force applied to the weighing device when the lifting member moves from the second position to the first position.

22. A container lifting and weighing assembly according to claim 21, wherein the container lifting and weighing assembly includes a load transfer mechanism configured to locate the weighing device positioned offset from a line of support between the container and the support surface.

23. A container lifting and weighing assembly according to claim 21, wherein the weighing device includes a load cell.

24. A container lifting and weighing assembly according to claim 21 or 22, wherein the container lifting and weighing assembly includes a plurality of weighing devices.

25. A container lifting and weighing assembly according to any one of claims 20 to 24, wherein, in combination, the lifting device abuts the support surface and a surface of the corner casting of the container, and the weighing device abuts a second surface of the twist lock and a second surface of the corner casting of the container.

26. A container lifting and weighing assembly of claim 20, wherein the weight indicator is a component of the actuator.

27. A container lifting and weighing assembly of claim 24, wherein the weight indicator provides an indication of the force applied to the lifting member in the second position.

28. A container lifting and weighing assembly according to any one of claims 20 to 26, wherein the lifting member is a pair of jaws.

29. A container lifting and weighing assembly according to claim 27, wherein the actuator includes a double-sided wedge driving the pair of jaws from the first position to the second position.

30. A container lifting and weighing assembly according to any one of claims 20 to 28, wherein the support surface is part of a twist lock inside a corner casting of the container.

31. A container lifting and weighing assembly according to claim 29, wherein, while the lifting member is in the second position the container remains substantially attached to the twist lock.

32. A container lifting and weighing assembly according to any one of claims 20 to 30, wherein the support surface is a ground surface.

33. A container lifting and weighing assembly according to claim 31, wherein the container is lifted no more than about 50 mm from the ground surface during weighing.

34. A container lifting and weighing assembly according to any one of claims 20 to 32, wherein the actuator is hydraulic.

35. A container lifting and weighing assembly according to any one of claims 20 to 33, wherein the container lifting and weighing assembly is portable.

36. A container lifting and weighing assembly according claim 34, wherein the container lifting and weighing assembly includes a carry bag.

37. A container lifting and weighing assembly according to claim 34, wherein the container lifting and weighing assembly includes four lifting devices in each carry bag.
